(19) United States
(12) Patent Application Publication
(10) Pub. No.: US 2005/0270263 A1
(43) Pub. Date: Dec. 8, 2005

(54) Source driver and a source line driving method using a gamma driving scheme for a liquid crystal display (LCD)

(75) Inventors: Kyung-Myun Kim, Seoul (KR); Yong-Guen Ku, Suwon-si (KR); Kyeong-Tae Moon, Suwon-si (KR); Hyo-Jin Ha, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/121,515

(22) Filed: May 4, 2005

(30) Foreign Application Priority Data
Jun. 8, 2004 (KR) 2004-41862

(51) Int. Cl. G09G 3/36

(52) U.S. Cl. 345/98

(57) ABSTRACT

Provided are a source driver and a source line driving method using a gamma driving scheme for a liquid crystal display (LCD) device. The source driver for driving the LCD device encodes serially input red (R), green (G), and blue (B) digital image data during a horizontal scan period, stores the encoded values of the R, G, and B digital image data in a first memory, and turns on or off grayscale voltage amplifiers included in a gamma voltage amplifying unit according to the encoded values stored in the first memory. Accordingly, when an output selecting unit selects a corresponding grayscale voltage output from the gamma voltage amplifying unit, and outputs the selected voltage to each source line, only the amplifiers necessary for driving a liquid crystal panel are turned on.

This application claims priority to Korean Patent Application No. 2004-41862, filed on Jun. 8, 2004, in the Korean Intellectual Property Office, the disclosure of which is incorporated herein in its entirety by reference.

### FIELD OF THE INVENTION

The present invention relates to a liquid crystal display (LCD), and more particularly, to a source driver for driving a source line of a thin film transistor (TFT)-LCD.

### DESCRIPTION OF THE RELATED ART

FIG. 1 is a block diagram of a conventional thin film transistor (TFT)-liquid crystal display (LCD) 100 including a TFT-LCD panel 110 and peripheral circuits. The LCD panel 110 is composed of an upper substrate superimposed on a lower substrate with liquid crystals disposed in between the two substrates. A plurality of electrodes are disposed on the two substrates to form an electric field and respective polarizing plates are disposed on the two substrates to polarize light. Brightness of light emitted by the TFT-LCD 100 is controlled by applying a voltage in accordance with a grayscale to the electrodes for rearranging liquid crystal cells. On the lower substrate of the LCD panel 110, a plurality of switching devices such as TFTs, which are connected to the electrodes, are provided so that the grayscale voltages can be applied to the electrodes. The switching devices control the brightness of emitted light on a pixel by pixel basis. Three colors, red (R), green (G), and blue (B), are represented by a pixel structure having a color filter array as illustrated in FIG. 2.

The TFT-LCD 100 includes a driving unit composed of gate drivers 120 for driving a plurality of gate lines formed in parallel rows on the LCD panel 110 and source drivers 130 for driving a plurality of source lines on the LCD panel 110, which are orthogonal to the gate lines, and a control unit (not shown) for controlling the driving unit to provide grayscale voltages to the electrodes through the switching devices. Generally, the control unit is not disposed on the LCD panel 110, however, in a chip-on-glass (COG) type LCD panel, the driving unit can be disposed on the LCD panel 110.

A conventional source driver, which operates using a gamma driving scheme, includes a plurality of amplifiers for amplifying grayscale voltages and a grayscale voltage selecting circuit for selecting the amplified grayscale voltages corresponding to source lines and for transferring the amplified grayscale voltages to the source lines. An example of a grayscale voltage selecting circuit is disclosed in Japanese Patent Laid-Open Publication No. JP 2002-132230. The grayscale voltages output from the grayscale voltage selecting circuit rapidly charge the source lines and corresponding pixels of an LCD panel. The brightness of light emitted by the pixels receiving the grayscale voltages is controlled by rearranging liquid crystal cells to be in proportion with corresponding grayscale voltages.

However, the grayscale voltage amplifiers and circuits for forming a conventional grayscale voltage selecting circuit, which are provided by source drivers, are complicated to design, occupy a large area, and consume a large amount of current. In particular, such grayscale voltage amplifiers generate and amplify more grayscale voltages than are typically necessary for driving pixels on an LCD panel, thus resulting in unnecessary current consumption. In addition, the current consumption increases when the outputs of the amplifiers oscillate. Further, as the conventional grayscale voltage selecting circuit is composed of a logic circuit for decoding three color, R, G, and B, digital image data, a level shifter is required to provide a grayscale voltage to each source line, thus leading to difficulties when implementing a conventional grayscale voltage selecting circuit with, for example, a mobile communication device.

A need therefor exists for a source driver that consumes a reduced amount of current and that requires a smaller surface area than a conventional source driver.

### SUMMARY OF THE INVENTION

According to an aspect of the present invention, there is provided a source driver for driving a liquid crystal display (LCD) device comprising: a no-load detecting unit for generating encoded values of received serial red (R), green (G), and blue (B) digital image data according to a grayscale of the R, G, and B digital image data during a horizontal scan period; a memory for storing the R, G, and B digital image data and the encoded values for the horizontal scan period; an amplifier control unit for generating an on/off control signal according to the encoded values; a gamma voltage amplifying unit including a plurality of amplifiers for amplifying grayscale voltages that are turned on or off in response to the on/off control signal; a line latch unit for sequentially outputting the R, G, and B digital image data stored in the memory during the horizontal scan period; and an output selecting unit for outputting a grayscale voltage to a plurality of source lines by selecting grayscale voltages that correspond to the R, G, and B digital image data among the amplified grayscale voltages output from the amplifiers that have been turned on during the horizontal scan period according to the R, G, and B digital image data output from the line latch unit.

The source driver may further include a reference voltage generating unit for generating a plurality of reference voltages using predetermined decoded values and a grayscale voltage generating unit for generating the grayscale voltages by subdividing the reference voltages. The source driver may further include a display mode selecting unit for outputting the R, G, and B digital image data to the output selecting unit in a normal mode, wherein the R, G, and B digital image data is output from the line latch unit during the horizontal scan period, or for outputting the R, G, and B digital image data corresponding to black or white R, G, and B digital image data to the output selecting unit during the horizontal scan period in a black/white mode.

The no-load detection unit may include a plurality of level detectors, each for generating one of the encoded values at a first logic state when none of the R, G, and B digital image data input during the horizontal scan period correspond to a predetermined level or for generating the encoded values at a second logic state when any of the R, G, and B digital image data input during a horizontal scan period corresponds to the predetermined level by determining whether any one of the R, G, and B digital image data corresponds to the predetermined level. Each of the level detectors may include an encoder for outputting the encoded value at a first logic state when none of the R, G, and B digital image data corresponds to a predetermined level or a second logic state when any of the R, G, and B digital image data corresponds to the predetermined level; a first latch unit for transferring the encoded value output from the encoder by checking the encoder output in every period when the R, G, and B digital image data is input; an inverter for inverting the output of the first latch unit; and a second latch unit for outputting the encoded value at a second logic state when the output of the inverter is at a first logic state at any time during the horizontal scan period, or at a first logic state when the output of the inverter is at a second logic state for the entire horizontal scan period.

The output selecting unit may include a plurality of driving voltage output units for outputting grayscale voltages corresponding to each of the R, G, and B digital image data, each of the driving voltage output units including a plurality of level selecting units for selecting a grayscale voltage that corresponds to the digital image data among the amplified grayscale voltages and for outputting the selected grayscale voltage to a corresponding source line. Each of the level selecting units may include a latch circuit which generates a first output control signal in response to a first control signal; a first metal oxide semiconductor field-effect transistor (MOSFET) which disables the first control signal in response to a second control signal; a decoding circuit which activates the first output control signal in response to any of the R, G, and B digital image data that corresponds to a source line to be driven and a third control signal; a first transfer gate which outputs or does not output the corresponding grayscale voltage among the amplified grayscale voltages according to whether the first output control signal is activated or deactivated; and a second transfer gate which outputs the output of the first transfer gate to a corresponding source line in response to a second output control signal.

According to another aspect of the present invention, there is provided a source line driving method of an LCD device comprising: generating encoded values of received serial R, G, and B digital image data and encoding the R, G, and B digital image data according to a grayscale of the R, G and B digital image data during a horizontal scan period; generating an on/off control signal according to the encoded values of the R, G, and B digital image data; turning on or turning off corresponding amplifiers among a plurality of amplifiers for amplifying grayscale voltages in response to the on/off control signal; and outputting a grayscale voltage to a plurality of source lines after selecting a grayscale voltage corresponding to the R, G, and B digital image data among the amplified grayscale voltages output from the amplifiers that have been turned on during the horizontal scan period according to the R, G, and B digital image data.

### BRIEF DESCRIPTION OF THE DRAWINGS

The above and other features of the present invention will become more apparent by describing in detail exemplary embodiments thereof with reference to the attached drawings in which:

FIG. 1 illustrates a conventional thin film transistor (TFT)-liquid crystal display (LCD);

FIG. 2 illustrates a pixel structure for use with a conventional TFT-LCD;

FIG. 3 illustrates a source driver according to an exemplary embodiment of the present invention;

FIG. 4 illustrates a pixel array of a liquid crystal panel driven by the source driver of FIG. 3;

FIG. 5 illustrates a no-load detection unit of FIG. 3;

FIG. 6 is a timing diagram of the no-load detection unit of FIG. 3;

FIG. 7 illustrates a display mode selecting unit of FIG. 3;

FIG. 8 illustrates an output selecting unit of FIG. 3;

FIG. 9 illustrates driving voltage output units of FIG. 8;

FIG. 10 illustrates a level selecting unit of FIG. 9;

FIG. 11 is a timing diagram of the level selecting unit of FIG. 10;

FIG. 12 illustrates an exemplary embodiment a decoding circuit of FIG. 10; and

FIG. 13 illustrates another exemplary embodiment of the decoding circuit of FIG. 10.

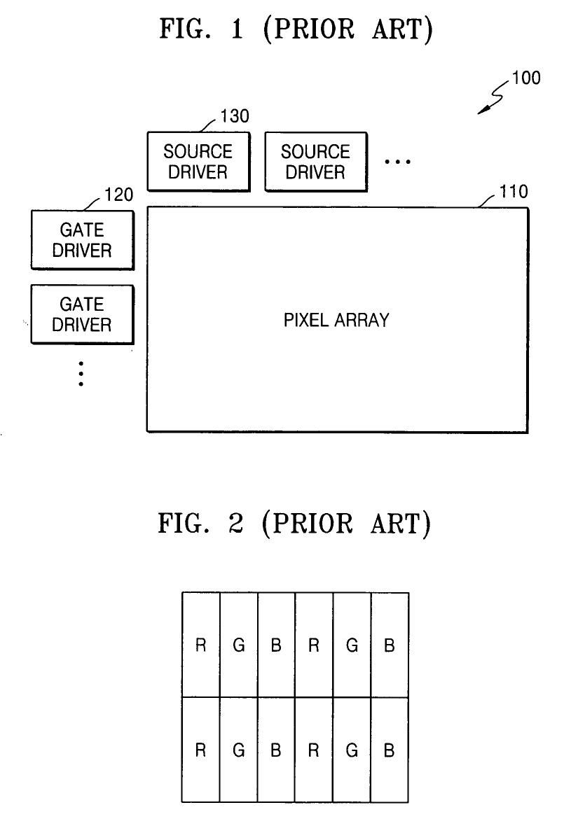

### DETAILED DESCRIPTION OF EXEMPLARY EMBODIMENTS

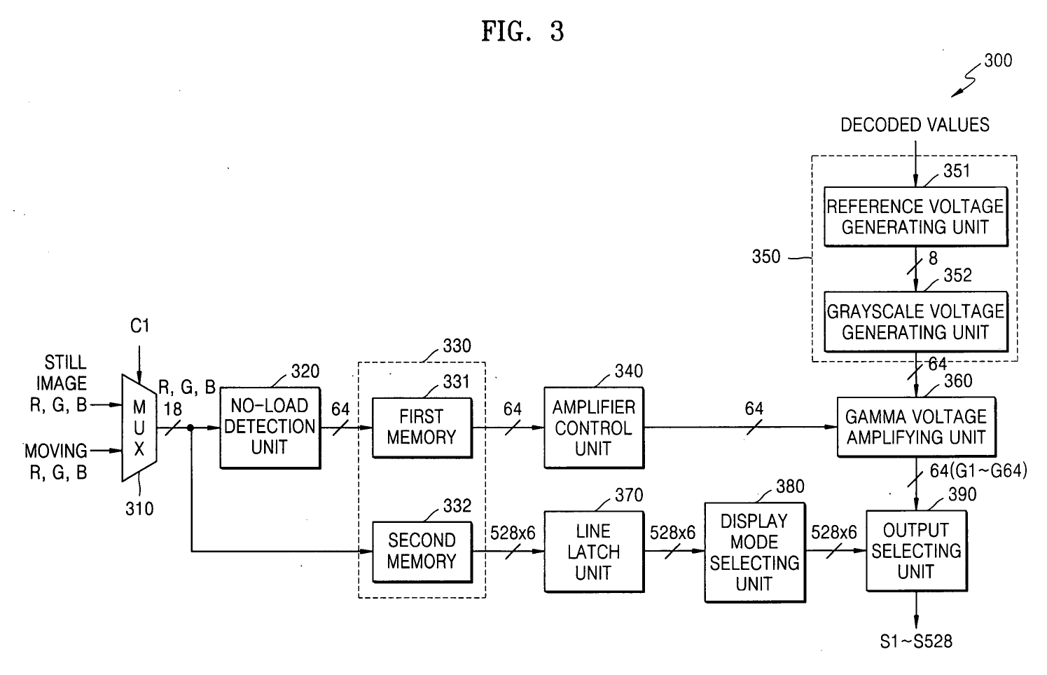

FIG. 3 illustrates a source driver 300 according to an exemplary embodiment of the present invention. Referring to FIG. 3, the source driver 300 includes a multiplexer (MUX) 310, a no-load detection unit 320, a memory 330, an amplifier control unit 340, a gamma adjusting unit 350, a gamma voltage amplifying unit 360, a line latch unit 370, a display mode selecting unit 380 and an output selecting unit 390. The source driver 300 is used to reduce the current consumed by amplifiers, which amplify grayscale voltages in the gamma voltage amplifying unit 360 and transistors for decoding red (R), green (G), and blue (B) digital image data, which are, for example, low voltage transistors, thereby decreasing a circuit area of the output selecting unit 390.

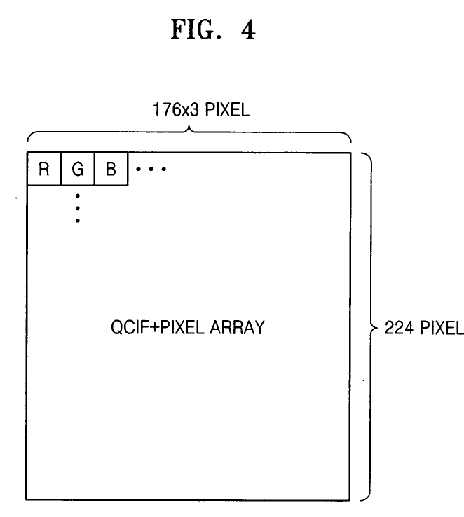

The MUX 310 outputs either serial R, G, and B digital image data for a still image or serial R, G, and B digital image data for a moving image according to a control signal C1 generated by a control unit (not shown). The source driver 300 drives a TFT (thin film transistor)-LCD (liquid crystal display) panel by processing the still image or the moving image using a gamma driving scheme. The TFT-LCD panel driven by the source driver 300 may be an LCD panel used in, for example, a mobile communication device or any LCD panel that uses a gamma driving scheme. In an exemplary embodiment of the present invention, the LCD panel has a quarter common intermediate format plus (QCIF+) resolution, which is driven as shown in FIG. 4. The QCIF+ has 528(=176*3)*224 pixels. The externally input serial R, G, and B digital image data are each composed of 6 bits, and each pixel of the serial R, G, and B digital image data represents over sixty-four grayscales of colors. In other words, the R, G, and B digital image data can represent more than 260K colors.

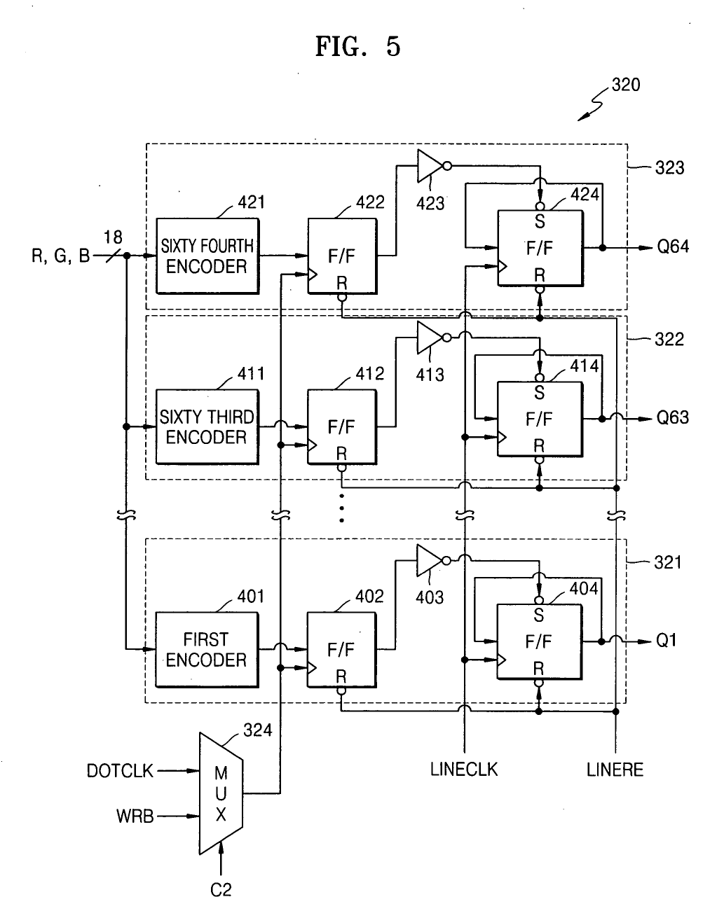

The no-load detection unit 320 generates encoded values Q1˜Q64 according to the serial R, G, and B digital image data for a moving image or a still image received from the MUX 310. The no-load detection unit 320 encodes the R, G, and B digital image data according to the grayscales of the R, G, and B digital image data during every horizontal scan period. The encoded values Q1˜Q64 are composed of 64 bits, and updated during every horizontal scan period. The no-load detection unit 320 generates the encoded values Q1˜Q64 to determine grayscale levels necessary for driving one scan line of the liquid crystal panel of FIG. 4. The no-load detection unit 320 then selects and turns on amplifiers for amplifying corresponding grayscale voltages in the gamma voltage amplifying unit 360. The operation of the no-load detection unit 320 will be described in detail hereinafter with reference to FIG. 5.

The memory 330 includes a first memory 331 and a second memory 332. The first memory 331 stores the 64-bit encoded values Q1˜Q64 for at least one horizontal scan period. The second memory 332 receives the R, G, and B digital image data input from the MUX 310, and stores the R, G, and B digital image data for at least one horizontal scan period. Data storage of the first memory 331 and second memory 332 depends on whether the source driver 300 is used to display a still image or a moving image. For example, when the source driver 300 is used to display a moving image, the first memory 331 stores the 64-bit encoded values Q1˜Q64 for one horizontal scan period, and when the source driver 300 is used to display a still image, the first memory 331 stores 224*64-bit encoded values Q1˜Q64 for one QCIF+frame. Similarly, when the source driver 300 is used to display a moving image, the second memory 332 stores the R, G, and B digital image data for one horizontal scan period, and when the source driver 300 operates to display a still image, the second memory 332 stores 528*224*6-bit R, G, and B digital image data during one QCIF+frame.

The amplifier controlling unit 340 generates an on/off control signal according to the 64-bit encoded values Q1˜Q64 during a horizontal scan period. The gamma voltage amplifying unit 360 includes sixty four amplifiers for amplifying each of the grayscale voltages, and turns on or off the corresponding amplifiers in response to the on/off control signal. For example, if the on/off control signal is composed of 64 bits, each of the amplifiers included in the gamma voltage amplifying unit 360 is controlled according to the logic state of the on/off control signal. The amplifiers that have been turned on amplify corresponding grayscale voltages and output the amplified grayscale voltages to the output selecting unit 390.

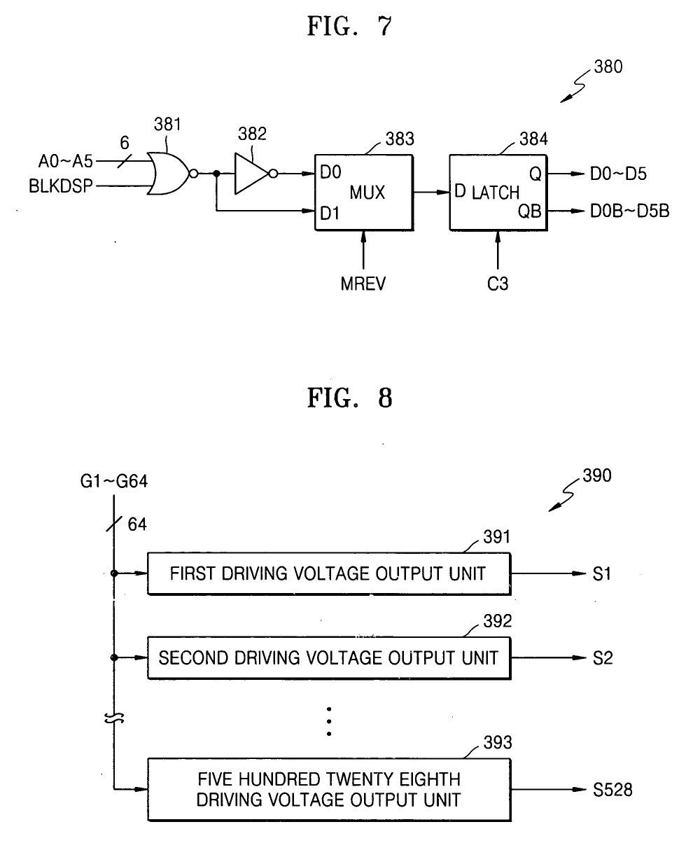

The line latch unit 370 outputs the R, G, and B digital image data of e.g., 528*6 bits, output from the second memory 332 in sequence during every horizontal scan period. The display mode selecting unit 380 outputs the R, G, and B digital image data output from the line latch unit 370 to the output selecting unit 390 during each horizontal scan period in a normal mode. In the normal mode, the display mode selecting unit 380 is not necessary, but when a black or white screen is to be displayed on the liquid crystal panel as shown in FIG. 4, e.g., in a black or white mode, the display mode selecting unit 380 outputs the R, G, and B digital image data as black and white data during each horizontal scan period. The operation of the display mode selecting unit 380 will be described in detail hereinafter with reference to FIG. 7. The display mode selecting unit 380 can also perform an AC-(alternating current) driving function by inverting the R, G, and B digital image data.

The output selecting unit 390 selects the grayscale voltages from the amplified grayscale voltages G1˜G64 output from the amplifiers that have been turned on in the gamma voltage amplifying unit 360 during the horizontal scan period according to the R, G, and B digital image data output from the display mode selecting unit 380 (when the display mode selecting unit 380 is not present, the line latch unit 370 is used), and outputs the selected grayscale voltages to a plurality of source lines S1˜S528. The operation of the output selecting unit 390 will be described in detail hereinafter with reference to FIGS. 8 through 10.

The gamma adjusting unit 350 includes a reference voltage generating unit 351 and a grayscale voltage generating unit 352. The reference voltage generating unit 351 generates eight reference voltages by using decoded values set in a register (not shown). The grayscale voltage generating unit 352 generates sixty-four grayscale voltages by subdividing the eight reference voltages. Thereafter, the sixty-four grayscale voltages are input to the sixty-four amplifiers in the gamma voltage amplifying unit 360, respectively.

FIG. 5 illustrates the no-load detection unit 320 of FIG. 3. Referring to FIG. 5, the no-load detection unit 320 includes a plurality of level detectors 321, 322 . . . 323 that receive the R, G, and B digital image data output from the MUX 310. Because each of the R, G, and B digital image data is composed of 6 bits, sixty-four grayscales can be represented, and thus sixty-four level detectors 321, 322 . . . 323 are needed. By using the level detectors 321, 322 . . . 323, the no-load detection unit 320 can generate the encoded values Q1˜Q64 during every horizontal scan period.

Each of the level detectors 321, 322 . . . 323 performs encoding according to the grayscale of R, G, and B digital image data input during a horizontal scan period to determine a grayscale level necessary for driving a scan line of the liquid crystal panel of FIG. 4. If a first grayscale is included in one of the R, G, and B digital image data input during the horizontal scan period, a first level detector 321 outputs a first encoded value Q1 in a second logic state (e.g., a logic high), and if a first grayscale is included in none of the R, G, and B digital image data, the first level detector 321 outputs the first encoded value Q1 at a first logic state (e.g., a logic low). Similarly, if a sixty-fourth grayscale is included in any of the R, G, and B digital image data input during the horizontal scan period, a sixty-fourth level detector 323 outputs a sixty-fourth encoded bit value Q64 in the second logic state, and if the sixty-fourth grayscale is not included in any of the R, G, and B digital image data, the sixty-fourth level detector 323 outputs a sixty-fourth encoded bit value Q64 in the first logic state.

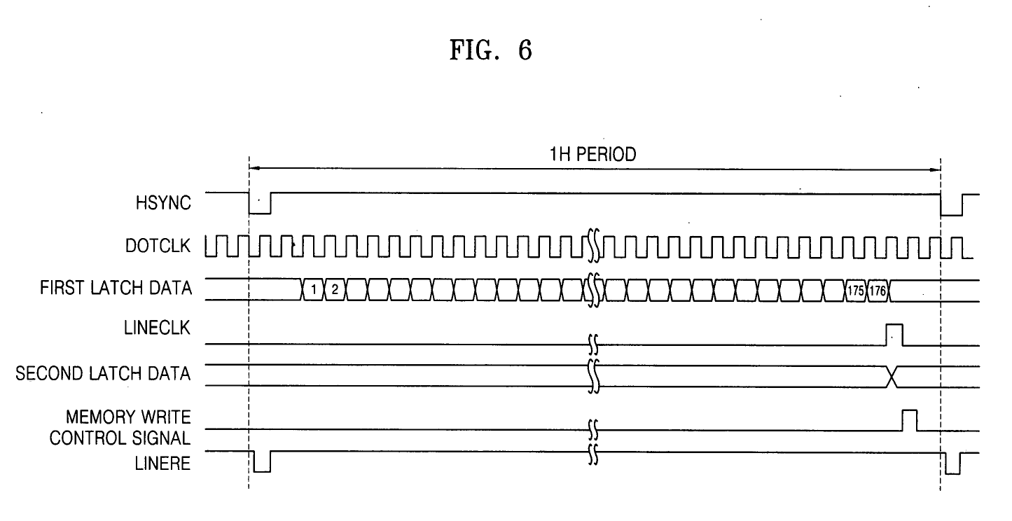

As shown in FIG. 5, each of the level detectors 321, 322 . . . 323 respectively include encoders 401, 411 . . . 421, first latch units 402, 412 . . . 422, inverters 403, 413 . . . 423, and second latch units 404, 414 . . . 424. The operation of the no-load detection unit 320 will also be described with reference to FIG. 6.

One of the encoders 401, 411 . . . 421 receives a set of R, G, and B digital image data of e.g., 18 bits. If any of the R, G and B digital image data corresponds to a predetermined grayscale level, one of the encoders 401, 411 . . . 421 outputs a corresponding encoded value at the second logic state. For example, if any of the received R, G, and B digital image data corresponds to a first grayscale level, e.g., “0”, a first encoder 401 of the first level detector 321 outputs a corresponding encoded value at the second logic state, and if not, the first encoder 401 outputs the corresponding encoded value at the first logic state.

TABLE 1

| R (RED) | G (GREEN) | B (BLUE) | Grayscale level |
|---|---|---|---|
| 111111 | 111111 | 111111 | 64 |
| 111110 | 111110 | 111110 | 63 |
| 111101 | 111101 | 111101 | 62 |
| 111100 | 111100 | 111100 | 61 |
| 111011 | 111011 | 111011 | 60 |
| 111010 | 111010 | 111010 | 59 |

.
.
.

| | | | |
|---|---|---|---|
| 000001 | 000001 | 000001 | 2 |
| 000000 | 000000 | 000000 | 1 |

As further shown in FIG. 5, one of the first latch units 402, 412 . . . 422, which may be a D flip-flop, checks an output of one of the encoders 401, 411 . . . 421 and transfers the logic state of the output of one of the encoders 401, 411 . . . 421 in response to a first pixel clock signal DOTCLK when the R, G, and B digital image data are moving image data, or a second pixel clock signal WRB when the R, G, and B digital image data are still image data. The first pixel clock signal DOTCLK or the second pixel clock signal WRB can be output by a MUX 324, which may be included in a control unit (not shown). The MUX 324 outputs the first pixel clock signal DOTCLK or the second pixel clock signal WRB according to the logic state of a second control signal C2 which indicates whether the R, G, and B digital image data is moving image data or still image data. The first pixel clock signal DOTCLK and the second pixel clock signal WRB are pulses having a period equal to an input period of the set of R, G, and B digital image data e.g., 18 bits. Therefore, one of the first latch units 401, 412 . . . 422 checks the output of one of the encoders 401, 411 . . . 421 during the period in which the set of R, G, and B digital image data is input, and transfers the output of one of the encoders 401, 411 . . . 421 to one of the inverters 403, 413 . . . 423.

One of the inverters 403, 413 . . . 423 then inverts and outputs the output of one of the first latch units 402, 412 . . . 422. One of the second latch units 404, 414 . . . 424, which may be an SR (set/reset) flip-flop, receives the inversion signal of one of the first latch units 402, 412 . . . 422 as a set signal. Because the output is fed back to an input point and the inversion signal of one of the first latch units 402, 412 . . . 422 is checked in response to a line clock signal LINECLK with a pulse having a horizontal scan period, one of the second latch units 404, 414 . . . 424 has an output at the first logic state when the output of one of the corresponding inverters 403, 413 . . . 423 outputs one of the corresponding encoded values Q1˜Q64 at the first logic state at least once during a horizontal scan period, or outputs one of the encoded values Q1˜Q64 at the second logic state.

As illustrated in FIG. 6, the generated encoded values Q1˜Q64 are stored by the first memory 331 in response to a memory write control signal generated in the control unit (not shown), and one of the first latch units 402, 412 . . . 422 and one of the second latch units 404, 414 . . . 424 are reset in response to a line reset signal LINERE having a period, equal to a horizontal scan period. These operations are repeated during every horizontal scan period. The control unit (not shown) can generate the first pixel clock signal DOTCLK, the second pixel clock signal WRB, the line clock signal LINECLK, and the line reset signal LINERE by using a horizontal scan synchronizing signal HSYNC.

In other words, after determining whether one of the R, G, and B digital image data is at a predetermined level, one of the level detectors 321, 322 . . . 323 generates one of the corresponding encoded values Q1˜Q64 at the first logic state when it is determined that none of the R, G, and B digital image data corresponds to the predetermined level, and generates one of the corresponding encoded values Q1˜Q64 at the second logic state when it is determined that any of the R, G, and B digital image data corresponds to the predetermined level. To generate a control signal to select amplifiers for amplifying the corresponding grayscale voltage in the gamma voltage amplifying unit 360 and to turn on/off the amplifiers, the encoded values Q1˜Q64 are stored in the first memory 331, and then input to the amplifier controlling unit 340.

FIG. 7 illustrates the display mode selecting unit 380 of FIG. 3. Referring to FIG. 7, the display mode selecting unit 380 includes a NOR logic circuit 381, an inverter 382, a MUX 383 and a latch circuit 384. The NOR logic circuit 381 performs a NOR operation on the R, G, and B digital image data (e.g., A0˜A5) output from the line latch unit 370 and on a black/white mode control signal BLKDSP generated by the control unit (not shown) and outputs the result. These operations can be performed simultaneously on the R, G, and B digital image data during one horizontal scan period corresponding to one horizontal line (e.g., 528 pixels) of a liquid crystal panel. The inverter 382 inverts the output of the NOR logic circuit 381, and outputs the inverted result. The MUX 383 selectively outputs the output of the NOR logic circuit 381 or the output of the inverter 382 according to a logic state of a predetermined control signal MREV generated by the control unit (not shown).

For example, in a normal mode, the black/white mode control signal BLKDSP is at the first logic state, and the MUX 383 outputs the R, G, and B digital image data output from the line latch unit 370 to the latch circuit 384. If a data inversion is needed to prevent liquid crystal degradation, the MUX 383 can selectively output either the output of the NOR logic circuit 381 or the output of the inverter 382 by changing the logic state of the predetermined control signal MREV In an exemplary embodiment of the present invention, when in the normal mode, and the control signal MREV is at the first logic state, the MUX 383 selects the output of the inverter 382, for example, the R, G, and B digital image data which is output from the line latch unit 370, and outputs the selected R, G, and B digital image data to the latch circuit 384.

Similarly, when in the black/white mode, and the black/white mode control signal BLKDSP is at the second logic state, the MUX 383 outputs either the output of the NOR logic circuit 381, which is in the first logic state, or the output of the inverter 382 which is in the second logic state, to the latch circuit 384. When the predetermined control signal MREV is at the first logic state, the MUX 383 outputs the output of the inverter 382 to the latch circuit 384, and when the predetermined control signal MREV is at the second logic state, the MUX 383 outputs the output of the NOR logic circuit 381 to the latch circuit 384. When the output of the MUX 383 is at the first logic state, a white screen is displayed on the liquid crystal panel, and when the output of the MUX 383 is at the second logic state, a black screen is displayed on the liquid crystal panel. The black or white screen can be alternately displayed on the liquid crystal panel according to a type of liquid crystal panel used.

As further shown in FIG. 7, the latch circuit 384 stores the output of the MUX 383, and outputs data D0˜D5 and D0B˜D5B in synchronization with a third control signal C3 generated by the control unit. The data D0˜D5 and D0B˜D5B output from the latch circuit 384 is input into the output selecting unit 390, and decoded therein. The data D0B˜D5B is an inversion of the data D0˜D5.

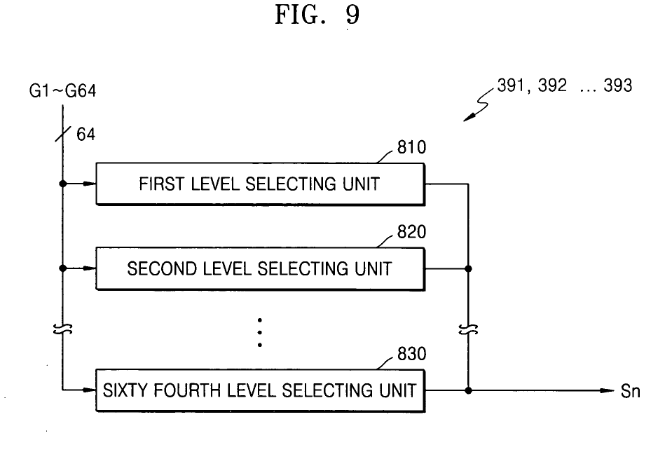

FIG. 8 illustrates the output selecting unit 390 of FIG. 3. Referring to FIG. 8, the output selecting unit 390 includes a plurality of driving voltage output units 391, 392 . . . 393. There are as many driving voltage output units 391, 392 . . . 393 as there are source lines S1˜S528 that output grayscale voltages corresponding to each of the R, G, and B digital image data. As shown, for example, in FIG. 9, each of the driving voltage output units 391, 392 . . . 393 includes sixty-four level selecting units 810, 820 . . . 830 that select a grayscale voltage corresponding to each of the R, G, and B digital image data among the amplified grayscale voltages in the gamma voltage amplifying unit 360 and outputs the selected grayscale voltage to their corresponding source lines.

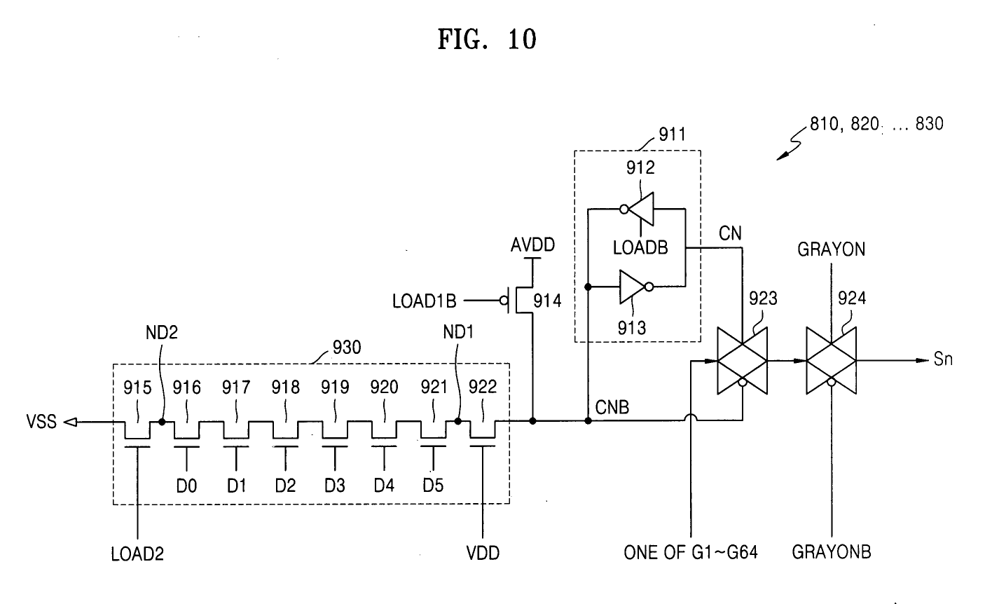

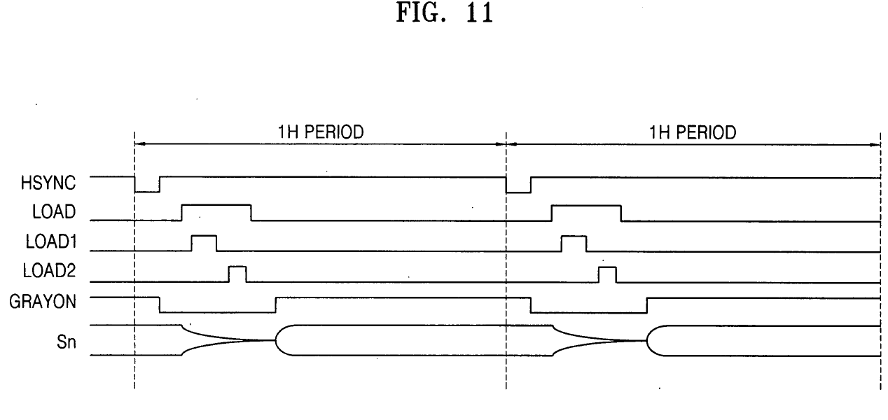

FIG. 10 illustrates one of the level selecting units 810, 820 . . . 830 in FIG. 9. Referring to FIG. 10, each of the level selecting units 810, 820 . . . 830 includes a latch circuit 911, a first MOSFET (metal-oxide-semiconductor field effect transistor) 914, a decoding circuit 930, a first transfer gate 923 and a second transfer gate 924. The operation of the level selecting units 810, 820 . . . 830 will also described with reference to FIG. 11. In an exemplary embodiment of the present invention, signals for controlling the level selecting units 810, 820 . . . 830, such as, a first control signal LOADB, a second control signal LOAD1B, a third control signal LOAD2 and second output control signals GRAYON and GRAYONB, are generated by the control unit. The signals LOADB and LOAD1B are inversions of the signals LOAD and LOAD1, respectively.

The latch circuit 911 includes a first inverter 912 that inverts input signals when the first control signal LOADB is activated at the second logic state, and a second inverter 913 that inverts the input signals without regard to the logic state of the first control signal LOADB. The latch circuit 911 latches input/output values when the first control signal LOADB is activated by feeding-back the input/output values, thus generating latched first output control signals CN and CNB. To simultaneously activate a negative (N)-type MOSFET and a positive (P)-type MOSFET, which constitute the first transfer gate 923, the first output control signals CN and CNB are in opposite logic states. As illustrated in FIG. 11, after the second control signal LOAD1B and the third control signal LOAD2 are sequentially activated, the first control signal LOADB is activated.

When the first control signal LOADB is deactivated, the first MOSFET 914 disables the one of first output control signals CNB and CN in response to the second control signal LOAD1B. When the second control signal LOAD1B is activated, the first MOSFET 914, which is a P-type MOSFET, disables one of the first output control signals CNB and CN by providing a first power, voltage AVDD to the second inverter 913 of the latch circuit 911.

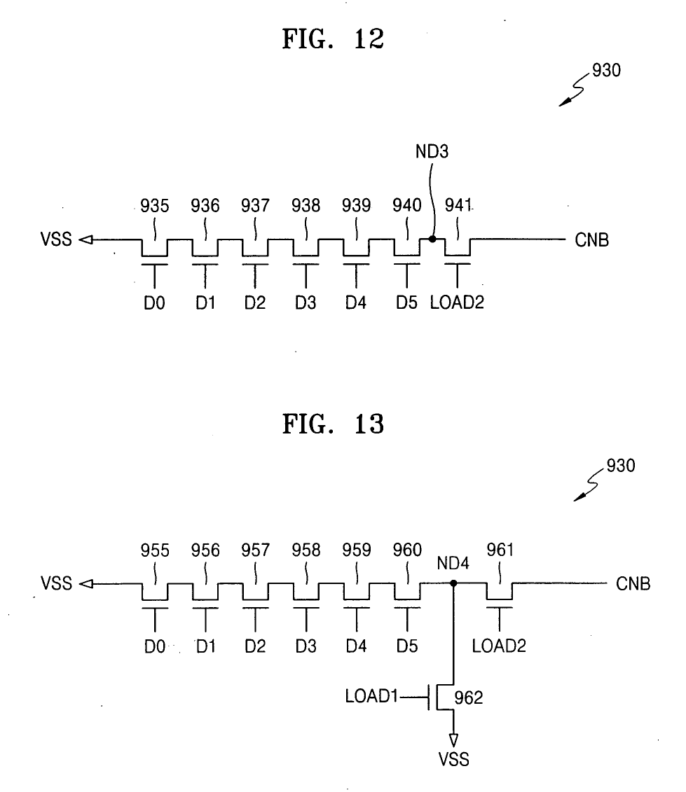

As further shown in FIG. 10, the decoding circuit 930 activates one of the first output control signals CNB and CN by decoding 6-bit R, G, and B digital image data (e.g., D0˜D5) corresponding to a source line to be driven among the R, G, and B digital image data in response to the third control signal LOAD2. All of the transistors included on the decoding circuit 930 are turned on in one of the sixty-four level selecting units 810, 820 . . . 830 included in the driving voltage output units 391, 392 . . . 393. Accordingly, signals that correspond to the first output control signals CN and CNB are activated in only one of the sixty-four level selecting units 810, 820 . . . 830 included in the driving voltage output units 391, 392 . . . 393. The decoding circuit 930 will be described in more detail with reference to FIG. 12.

The first transfer gate 923, which includes an N-type MOSFET and a P-type MOSFET connected in parallel, may or may not output a grayscale voltage corresponding to a source line to be driven among the grayscale voltages amplified by the amplifiers selected and turned on by the gamma voltage amplifying unit 360 according to the activation or deactivation of one of the first output control signals CN and CNB. For example, when one of the first output control signals CN are CNB is activated by the decoding circuit 930, the first transfer gate 923 outputs a corresponding grayscale to the second transfer gate 924. The second transfer gate 924 then outputs an output of the first transfer gate 923 to a corresponding source line in response to the second output control signals GRAYONB and GRAYON. The second transfer gate 924 includes an N-type MOSFET and a P-type MOSFET connected in parallel. To activate both of the MOSFETs, the second output control signals GRAYONB and GRAYON are inverted with respect to each other.

As shown in FIG. 10, the decoding circuit 930 includes a second MOSFET 922, a plurality of MOSFETs 916-921 and a third MOSFET 915. The MOSFETs 916-921 and the third MOSFET 915 are low-voltage MOSFETs, and operate at a lower voltage than the latch circuit 911, the first MOSFET 914, the second MOSFET 922, the first transfer gate 923, and the second transfer gate 924. In accordance with an exemplary embodiment of the present invention, because the decoding circuit 930 operates at a lower voltage, lower-voltage MOSFETs, which are smaller in size, can be used, thus reducing the area of the decoding circuit 930.

The second MOSFET 922 includes a gate terminal connected to a second power source VDD, a drain terminal connected to a node (e.g., CNB node) associated with one of a pair of signals that constitute one of the first output control signals CN and CNB, and a source terminal connected to a first node ND1. The second MOSFET 922 is disposed between the MOSFETs 916-921, which are low voltage MOSFETs, and the MOSFET 914, which is a high-voltage MOSFET, prevent a breakdown of the MOSFETs 916-921 that could result from a high-voltage. To do this, the gate terminal of the second MOSFET 922 is turned on by a second power source VDD having a lower voltage level than the first power source AVDD. Each of the MOSFETs 916-921 includes a gate terminal that receives a bit of R, G, and B digital image data to drive a corresponding source line, and the MOSFETs 916-921 are connected to the first node ND1 in series. The source terminal of the first MOSFET 916 of the plurality of MOSFETs 916-921 is connected to a second node ND2 and the third MOSFET 915 includes a gate terminal that receives the third signal LOAD2, a drain terminal connected to the second node ND2, and a source terminal that is grounded.

The MOSFETs 916-921 included in each of the sixty-four level selecting units 810, 820 . . . 830 receive and decode R, G, and B digital image data to drive a source line. For example, the MOSFETs 916-921 included in the sixty-fourth level selecting unit 830 receive the R, G, and B digital image data (e.g., D0˜D5) to be decoded from the display mode selecting unit 380. Corresponding MOSFETs included in a sixty-third level selecting unit (not shown) through the first level selecting unit 810 receive the R, G, and B digital image data (e.g., D0˜D5) to be decoded corresponding to the first through sixty-third grayscales. Accordingly, in only one of the sixty-four level selecting units 810, 820 . . . 830 included in each of the driving voltage output units 391, 392 . . . 393, all of the transistors in the decoding circuit 930 are turned on, thus a signal corresponding to one of the first output control signals CN and CNB is activated in only one of the sixty-four level selecting units 810, 820 . . . 830 included in each of the driving voltage output units 391, 392 . . . 393.

FIG. 12 illustrates an exemplary embodiment of the decoding circuit 930 of FIG. 10. Referring to FIG. 12, the decoding circuit 930 includes a second MOSFET 941 and a plurality of MOSFETs 935-940. The MOSFETs 935-940 are low-voltage MOSFETs that require less circuit area and operate at a lower voltage than the latch circuit 911, the first MOSFET 914, the second MOSFET 941, the first transfer gate 923, and the second transfer gate 924. The second MOSFET 941 includes a gate terminal that receives the third control signal LOAD2, a drain terminal connected to a node associated with one of a pair of signals which constitutes one of the first output control signals CN and CNB, and a source terminal connected to a predetermined node ND3. The second MOSFET 941 is connected between the MOSFETs 935-940 and the high-voltage MOSFET 914, and prevents a breakdown of the low-voltage MOSFETs 935-940 that may be caused by a high voltage. In each of the MOSFETs 935-940, a gate terminal receives a bit of the R, G, and B digital image data which drives a corresponding source line, and the MOSFETs 935-940 are connected in series to the predetermined node ND3. Further, a source terminal of the MOSFET 935 is grounded.

FIG. 13 illustrates another exemplary embodiment of the decoding circuit 930 of FIG. 10. Referring to FIG. 13, the decoding circuit 930 includes a second MOSFET 961, a third MOSFET 962 and a plurality of MOSFETs 955-960. The MOSFETs 955-960 and the third MOSFET 962 are low-voltage MOSFETs which require less circuit area and operate at a lower voltage than the latch circuit 911, the first MOSFET 914, the second MOSFET 916, the first transfer gate 923, and the second transfer gate 924. The second MOSFET 961 includes a gate terminal that receives the third control signal LOAD2, a drain terminal connected to a node (e.g., a CNB node) for one of a pair of signals that constitute one of the first output control signals CN and CNB, and a source terminal connected to a predetermined node ND4. The third MOSFET 962 includes a gate terminal that receives a signal LOAD1, which is an inversion of the second control signal LOAD1B, a drain terminal connected to the predetermined node ND4, and a source terminal that is grounded. Each of MOSFETs 955-960 includes a gate terminal that receives a bit of R, G, and B digital image data, which drives the corresponding source line, and the MOSFETs 955-960 are connected in series to the predetermined node ND4. Further, a source terminal of the MOSFET 955 is grounded.

As described above, a source driver for driving an LCD device according to an exemplary embodiment of the present invention encodes serially input R, G, and B digital image data during a horizontal scan period, stores the encoded values in a first memory, and turns on/off grayscale voltage amplifiers included in a gamma voltage amplifying unit according to values stored in the first memory. Accordingly, when an output selecting unit selects a corresponding grayscale voltage output from the gamma voltage amplifying unit and outputs the selected voltage to each source line of a liquid crystal panel, only the amplifiers necessary for driving the liquid crystal panel are turned on.

Also described above, a source driver for driving an LCD device according to an exemplary embodiment of the present invention drives source lines by turning on only grayscale voltage amplifiers necessary for driving a liquid crystal panel, thereby reducing current consumption and preventing amplifier oscillation. In addition, because low-voltage transistors are used, for example, in the source driver, a level shifter is not needed, thus reducing the circuit area of the source driver.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A source driver for driving a liquid crystal display (LCD) comprising:
a no-load detecting unit for generating encoded values of received serial red (R), green (G), and blue (B) digital image data according to a grayscale of the R, G, and B digital image data during a horizontal scan period;
a memory for storing the R, G, and B digital image data and the encoded values for the horizontal scan period;
an amplifier control unit for generating an on/off control signal according to the encoded values;
a gamma voltage amplifying unit including a plurality of amplifiers for amplifying grayscale voltages that are turned on or off in response to the on/off control signal;
a line latch unit for outputting the R, G, and B digital image data stored in the memory during the horizontal scan period; and
an output selecting unit for outputting a grayscale voltage to a plurality of source lines by selecting grayscale voltages that correspond to the R, G, and B digital image data among the amplified grayscale voltages output from the amplifiers that have been turned on during the horizontal scan period according to the R, G, and B digital image data output from the line latch unit.

2. The source driver of claim 1, further comprising:
a reference voltage generating unit for generating a plurality of reference voltages using first decoded values; and
a grayscale voltage generating unit for generating the grayscale voltages by subdividing the reference voltages.

3. The source driver of claim 1, further comprising:
a display mode selecting unit for performing one of outputting the R, G, and B digital image data to the output selecting unit in a normal mode, outputting the R, G, and B digital image data output from the line latch unit during the horizontal scan period, and outputting the R, G, and B digital image data corresponding to black or white R, G, and B digital image data to the output selecting unit during the horizontal scan period when in a black/white mode.

4. The source driver of claim 1, wherein the serial R, G, and B digital image data is one of still image digital data and moving image digital data.

5. The source driver of claim 4, wherein the memory includes:
a first memory for storing the encoded values for the horizontal scan period; and
a second memory for storing the R, G, and B digital image data for the horizontal scan period.

6. The source driver of claim 5, wherein the first memory and the second memory store the encoded values and the R, G, and B digital image data for the horizontal scan period when the R, G, and B digital image data is moving image digital data, and the first and the second memories store the encoded values and the R, G, and B digital image data for one frame when the R, G, and B digital image data is still image digital data.

7. The source driver of claim 1, wherein the no-load detection unit includes:
a plurality of level detectors, each for performing one of generating an encoded value at a first logic state when none of the R, G, and B digital image data input during the horizontal scan period correspond to a first level and generating the encoded values at a second logic state when one of the R, G, and B digital image data input during the horizontal scan period corresponds to the first level.

8. The source driver of claim 7, wherein each of the level detectors includes:
an encoder for outputting one of the encoded values at one of a first logic state when none of the R, G, and B digital image data correspond to the first level and a second logic state when one of the R, G, and B digital image data corresponds to the first level;
a first latch unit for transferring the encoded value output from the encoder by checking the encoder output during each input period of the R, G, and B digital image data;
an inverter for inverting the output of the first latch unit; and
a second latch unit for outputting the encoded value at one of the second logic state when the output of the inverter is at the first logic state during the horizontal scan period, and at the first logic state when the output of the inverter is at the second logic state for the entire horizontal scan period.

9. The source driver of claim 1, wherein the output selecting unit includes:
a plurality of driving voltage output units for outputting grayscale voltages corresponding to the R, G, and B digital image data, wherein each of the driving voltage output units includes a plurality of level selecting units for selecting a grayscale voltage that corresponds to the R, G, and B digital image data among the amplified grayscale voltages and for outputting the selected grayscale voltage to a corresponding source line.

10. The source driver of claim 9, wherein each of the level selecting units includes:
a latch circuit for generating a first output control signal in response to a first control signal;
a first metal oxide semiconductor field-effect transistor (MOSFET) for disabling the first control signal in response to a second control signal;
a decoding circuit for activating the first output control signal in response to one of the R, G, and B digital image data that corresponds to a source line to be driven and a third control signal;
a first transfer gate for outputting the corresponding grayscale voltage among the amplified grayscale voltages when the first output control signal is activated and for not outputting the corresponding grayscale voltage among the amplified grayscale voltages when the first output control signal is deactivated; and
a second transfer gate for outputting the output of the first transfer gate to a corresponding source line in response to a second output control signal.

11. The source driver of claim 10, wherein the first MOSFET is a positive-channel MOSFET.

12. The source driver of claim 10, wherein the first output control signal includes a pair of signals having different logic states, and the decoding circuit includes:
a second MOSFET having a gate terminal connected to a power source, a drain terminal connected to a node of one of the pair of signals, and a source terminal connected to a first node;
a plurality of MOSFETs, each having a gate terminal for receiving a bit of the R, G, and B digital image data to drive a corresponding source line, the plurality of MOSFETs connected in series to the first node, and a source terminal of a last MOSFET of the plurality of MOSFETs connected to a second node; and
a third MOSFET having a gate terminal for receiving the third control signal, a drain terminal connected to the second node, and a source terminal connected to ground.

13. The source driver of claim 12, wherein each of the plurality of MOSFETs and the third MOSFET operate at a lower-voltage than the first MOSFET.

14. The source driver of claim 10, wherein the first output control signal includes a pair of signals having different logic states, and the decoding circuit includes:
a second MOSFET having a gate terminal for receiving the third control signal, a drain terminal connected to a node of one of the pair of signals, and a source terminal connected to a first node; and
a plurality of MOSFETs, each having a gate terminal for receiving a bit of the R, G, and B digital image data to drive a corresponding source line, the plurality of MOSFETs connected in series to the first node, and a source terminal of a last MOSFET of the plurality of MOSFETs connected to ground.

15. The source driver of claim 14, wherein each of the plurality of MOSFETs operates at a lower voltage than the first MOSFET.

16. The source driver of claim 10, wherein the first output control signal includes a pair of signals having different logic states, and the decoding circuit includes:
a second MOSFET having a gate terminal for receiving the third control signal, a drain terminal connected to a node of one of the pair of signals, and a source terminal connected to a first node;
a third MOSFET having a gate terminal for receiving an inverted signal of the second control signal, a drain terminal connected to the first node, and a grounded source terminal; and
a plurality of MOSFETs, each having a gate terminal for receiving a bit of the R, G, and B digital image data to drive a corresponding source line, the plurality of MOSFETs connected to in series to the first node, and a source terminal of a last MOSFET of the plurality of MOSFETs connected to ground.

17. The source driver of claim 16, wherein each of the plurality of MOSFETs and the third MOSFET operate at a lower voltage than the first MOSFET.

18. A source line driving method for use with a liquid crystal display (LCD) comprising:
generating encoded values of received serial red (R), green (G), and blue (B) digital image data according to a grayscale of the R, G, and B digital image data during a horizontal scan period;
generating an on/off control signal according to the encoded values;
performing one of turning on and off corresponding amplifiers among a plurality of amplifiers for amplifying grayscale voltages in response to the on/off control signal; and
outputting a grayscale voltage to a plurality of source lines after selecting a grayscale voltage corresponding to the R, G, and B digital image data among the amplified grayscale voltages output from the amplifiers that have been turned on during the horizontal scan period according to the R, G, and B digital image data.

19. The method of claim 18, further comprising:
generating a plurality of reference voltages using decoded values; and
generating the grayscale voltages by subdividing the reference voltages.

20. The method of claim 18, further comprising:
outputting one of a grayscale voltage to a corresponding source line according to the R, G, and B digital image data of a still image or a moving image in a normal mode, and a grayscale voltage to a corresponding source line according to black or white R, G, and B digital image data in a black/white mode.

21. The method of claim 18, wherein the step of generating the encoded values includes:
determining a first level that the R, G, and B digital image data corresponds to during the horizontal scan period; and
generating the encoded value at one of a first logic state when the R, G and B digital image data does not correspond to the first level corresponding to the encoded value and a second logic state when one of the R, G and B digital image data corresponds to the first level corresponding to the encoded value.

22. The source line driving method of claim 18, wherein the step of outputting the grayscale voltage to the source lines after selecting the grayscale voltage includes:
generating a first output control signal in response to a first control signal;
disabling the first output control signal in response to a second control signal;
activating the first output control signal in response to one of the R, G, and B digital image data which corresponds to a source line to be driven and a third control signal; and
performing one of outputting a corresponding grayscale voltage among the amplified grayscale voltages when the first output control signal is activated and not outputting the corresponding grayscale voltage among the amplified grayscale voltages when the first output control signal is deactivated.

23. The method of claim 22, wherein the step of decoding the R, G, and B digital image data is performed by a decoding circuit including low-voltage metal oxide semiconductor field-effect transistors (MOSFETs).
